(19) United States
(12) Patent Application Publication
(10) Pub. No.: US 2026/0030166 A1
(43) Pub. Date: Jan. 29, 2026

(54) LATENCY DETERMINATION

(71) Applicant: Arm Limited, Cambridge (GB)

(72) Inventor: Scott Courtland HADLEY, Austin, TX (US)

(21) Appl. No.: 18/785,499

(22) Filed: Jul. 26, 2024

(51) Int. Cl. G06F 12/0862; G06F 3/06

(52) U.S. Cl. CPC G06F 12/0862; G06F 3/0611; G06F 3/0653; G06F 3/0673

(57) ABSTRACT

An apparatus includes: latency determination circuitry configured to determine a predicted exposed latency associated with a memory load request targeting an address in memory, the predicted exposed latency corresponding to a stall that would be caused by waiting for the memory load request to complete had the data stored at the address in memory targeted by the memory load request not been prefetched into a cache; and prefetch control circuitry configured to control issuing of prefetch requests to prefetch data from a memory system based on the predicted exposed latency.

### BACKGROUND

### Technical Field

The present technique relates to the field of data processing. More particularly, but not exclusively, the present technique relates to prefetching.

### Technical Background

Prefetching is a technique used by a data processing apparatus to mitigate against the latency associated with memory access, by generating a prefetch request to retrieve data values or instructions from memory before the data processing apparatus encounters the corresponding instructions to fetch those data values or instructions.

### SUMMARY

At least some examples of the present technique provide an apparatus comprising:
latency determination circuitry configured to determine a predicted exposed latency associated with a memory load request targeting an address in memory, the predicted exposed latency corresponding to a stall that would be caused by waiting for the memory load request to complete had the data stored at the address in memory targeted by the memory load request not been prefetched into a cache; and
prefetch control circuitry configured to control issuing of prefetch requests to prefetch data from a memory system based on the predicted exposed latency.

At least some examples of the present technique provide a system comprising:
the apparatus described above, implemented in at least one packaged chip;
at least one system component; and
a board,
   wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a non-transitory computer-readable medium storing computer-readable code for fabrication of an apparatus as described above.

At least some examples of the present technique provide a method comprising:
determining a predicted exposed latency associated with a memory load request targeting an address in memory, the predicted exposed latency corresponding to a stall that would be caused by waiting for the memory load request to complete had the data stored at the address in memory targeted by the memory load request not been prefetched into a cache; and
controlling issuing of prefetch requests to prefetch data from a memory system based on the predicted exposed latency.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example data processing system.

FIG. 2 illustrates latency determination circuitry and prefetch control circuitry as discussed herein.

FIG. 3 illustrates total latency, hidden latency, and exposed latency for a memory load request.

FIG. 4 illustrates an example latency scenario for a prefetched memory load request.

FIG. 5 illustrates an example latency scenario for a prefetched memory load request.

FIG. 6 illustrates example steps for determining a predicted exposed latency as discussed herein.

FIG. 7 illustrates examples steps for controlling the issuing of prefetch requests based on determining a predicted exposed latency as discussed herein.

FIG. 8 illustrates a system and a chip-containing product.

### DESCRIPTION OF EXAMPLES

As discussed above, prefetching can be used to mitigate against the latency associated with memory access, by generating a prefetch request to retrieve data (i.e. data values or instructions) from memory before the data processing apparatus encounters the corresponding instructions to fetch that data. However, there can be constraints on the amount of prefetching that is possible in a given implementation (i.e. in view of memory bandwidth, processing resources, etc.) and thus it can be beneficial to prefetch data values/instructions for a memory load request when doing so would result in a useful performance improvement.

One way of determining whether to prefetch a given memory load request is based on cache hit or miss. However, cache misses may not be equal, as one cache miss may miss in a level one cache, and then fill from a level two cache (i.e. it may miss in a cache and then fill from the next fastest cache), whereas another cache miss may miss in the level one cache and then fill from main memory. Thus, a further way of determining whether to prefetch a given memory load request is based on determining a predicted load criticality associated with the given memory load request. A load may be considered critical when the memory load causes a processing stall or introduces a latency above a given criticality threshold, for example in that the processing pipeline is stalled as a result of waiting for that memory load request to complete. It can therefore be beneficial to target prefetching at memory load requests that are critical (i.e. that would cause a processing stall or that introduce a latency above a given threshold), and avoid prefetching memory load requests which do not cause processing stalls or that introduce a latency below a given threshold. By doing so, prefetching performance can be increased because the prefetching can be targeted at memory load requests where a useful performance increase can be realised and memory bandwidth is not used for unnecessary prefetching where a useful performance increase is not realised. Thus, the latency associated with memory access can be reduced.

One way of determining whether to prefetch data (i.e. data values/instructions) for a memory load request is to measure an exposed latency of the memory load request, and prefetch memory load requests having high exposed latency (that is greater than a predetermined threshold for example). As discussed herein, exposed latency refers to the latency corresponding to a stall caused by waiting for the memory load request to complete.

However, the present inventor has identified that, because prefetching a memory load request affects the latency of the load, using the measured latency of the load to determine whether to prefetch the load can result in undesirable cyclical behavior that increases memory bandwidth and processing resource usage. For example, once a memory load request starts being covered by prefetching (i.e. the data values/instructions of the memory load request are prefetched), the measured exposed latency associated with the memory load request will decrease, for example below a given prefetching threshold (so as to be considered non-critical), resulting in the memory load request no longer being prefetched. This can result in a cyclical pattern of behavior, whereby: a memory load has a high exposed latency; the memory load request is therefore considered critical and is prefetched; the exposed latency decreases; the memory load request is no longer considered critical and is not prefetched; and the exposed latency of the memory load request increases again. This cyclical pattern of behavior can address critical loads temporarily, by prefetching a critical load, but causes further prefetching being required for that load at a future time (i.e. once the load becomes critical again) as a result of the way the criticality of the load is determined.

One way to address this cyclical pattern is to permanently mark a memory load as critical once it is considered critical the first time. However, the present inventor has identified that this can be over-aggressive. A memory load may be critical while a cache is ‘warming-up’ (i.e. the period during which data is being initially loaded into a cache) but may no longer be critical once the data/instructions targeted by the memory load becomes cache-resident. Further, there may be a phase change in software where a memory load that was on a critical path (i.e. its latency was increasing towards a predetermined criticality threshold) is no longer on a critical path. Thus, it would be beneficial to stop prefetching the memory load in these cases to avoid using memory bandwidth on unnecessarily prefetching memory loads that are marked as critical (and thus are prefetched) when the memory loads are not or no longer actually critical.

Thus, in the examples discussed below, an apparatus is provided with latency determination circuitry configured to determine a predicted exposed latency associated with a memory load request targeting an address in memory, the predicted exposed latency corresponding to a stall that would be caused by waiting for the memory load request to complete had the data stored at the address in memory targeted by the memory load request not been prefetched into a cache; and prefetch control circuitry configured to control issuing of prefetch requests to prefetch data from a memory system based on the predicted exposed latency.

Hence, rather than using a measured exposed latency to determine whether to prefetch a memory load (and thus experience the cyclical pattern of behavior as discussed above), a predicted exposed latency is used. The predicted exposed latency of a memory load corresponds to the exposed latency that there would have been had the memory load request not been prefetched (i.e. had the data stored at the address in memory targeted by the memory load request not been prefetched into a cache). That is to say, a prediction is made as to the exposed latency that would have been experienced by a given memory load request had the memory load request not been prefetched (even when the memory load request has actually been prefetched). From one perspective, the predicted exposed latency can be considered a theoretical or hypothetical exposed latency, because it refers to a latency that is not directly measured.

By using the predicted exposed latency to determine whether to prefetch a load, the cyclical pattern of behavior described above can be avoided. Further, the approach can be responsive to changes in the criticality of a memory load, because if a memory load is no longer actually critical, the predicted exposed latency will decrease in line with the change in criticality (in contrast to an approach where a memory load is permanently marked as critical).

Hence, with the present technique, the likelihood that a memory load will be prefetched unnecessarily is reduced, thereby reducing the likelihood that memory bandwidth is used for unnecessary prefetching. Further, by using a predicted exposed latency as discussed herein, the latency of a prefetched memory load can be determined without affecting the latency actually experienced by the memory load, thus avoiding the cyclical pattern of behaviour discussed herein that results in increased memory bandwidth and processing resource usage.

It will be appreciated that a memory load request may cause a stall (for example a processing stall in a processing pipeline) at a variety of points or stages in a processing pipeline. For example, a memory load request may cause a stall when the memory load request is at the head of a load queue, the head of a re-order buffer, or the head of an in-order pipeline etc. as examples. Hence, a memory load request may cause a stall when the memory load request is at a point in a processing pipeline when the processing pipeline is reliant on the memory load request completing before further instructions may be completed. In some examples, a stall corresponds to a delay experienced by processing circuitry in the completion of instructions.

In some examples, the latency determination circuity is configured to determine the predicted exposed latency that would be caused had the data stored at the address in memory targeted by the memory load request had not been prefetched into the cache even when the data stored at the address in memory targeted by the memory load request has actually been prefetched into the cache.

In some examples, the latency determination circuitry is configured to determine the predicted exposed latency based on determining a hidden latency, the hidden latency corresponding to an amount of time between when the memory load request starts executing and when the memory load request would start causing the stall had the data stored at the address in memory targeted by the memory load request not been prefetched into the cache.

It will be appreciated that in some implementations (such as out-of-order processing implementations) other instructions may be executing in parallel while a memory load request is executing and before the memory load request reaches a point where it would start causing a stall had the memory load request not been prefetched, and thus the latency may be considered hidden in the sense that it is not causing the processing pipeline to stall as a result of the memory load request itself because other instructions are being executed at the same time. The hidden latency may be determined based on a difference in time between when the memory load request starts executing and when the memory load request reaches a point in a processing pipeline where, had the memory load request not been prefetched, the memory load request would cause a stall. For example, the hidden latency may be determined based on a difference in time between when the memory load request starts executing and when the memory load request reaches a head of a processing pipeline (such as a head of a load queue, a head of a re-order buffer, a head of an in-order pipeline, for example). It will be appreciated that hidden latency may occur in in-order processing implementations as well.

In some examples, the times at which a memory load request starts executing and when it reaches a point in a processing pipeline where a stall would be caused had the memory load request not been prefetched can be tracked or determined. For example, a timestamp at which the memory load request reaches the head of a load queue, head of a re-order buffer, or in-order pipeline can be determined and compared with a timestamp at which the memory load request started executing. Thus, the hidden latency for a memory load request can be determined (even when the memory load request has been prefetched).

In some examples, the latency determination circuitry is configured to determine the predicted exposed latency based on predicting a total latency, the total latency being indicative of an amount of time between when the memory load request starts executing and when the memory load request would complete had the data stored at the address in memory targeted by the memory load request not been prefetched into the cache.

In examples, the total latency is predicted because a measurement of the total latency cannot be performed, as the point at which the memory load request completes had the data stored at the address in memory targeted by the memory load request not been prefetched into the cache cannot be determined for that memory load request (because the data has actually been prefetched into the cache). In other words, in examples, for the memory load request that is covered by prefetching, the total latency cannot be directly measured because that memory load request has actually been covered by prefetching. However, as discussed herein, the total latency that would have been incurred had the memory load request not been covered by prefetching can be predicted.

In examples, the latency determination circuitry is configured to predict the total latency based on determining a data source of a prefetched cache line containing the data stored at the address in memory targeted by the memory load request. Thus, the data source (for example a level two cache, level three cache, system level cache, main memory etc.) of the prefetched cache line may be used to predict the total latency. In some examples, information indicative of where a prefetched cache line was prefetched from can be tracked. Hence, the total latency may be predicted as if the data was still present in its original location (i.e. the data source where the data was prefetched from).

It will be appreciated that the data source of the prefetched cache line may depend on the cache that the data stored at the address in memory targeted by the memory load request is prefetched into. For example, when the cache that the data stored at the address in memory targeted by the memory load request is prefetched into is a lowest level or first-level cache (i.e. L1 cache), the data source may correspond to a level two cache (L2 cache), level three cache (l3 cache), system level cache, or main memory. However, it will be appreciated that the cache that the data stored at the address in memory targeted by the memory load request is prefetched into may be another level of cache, for example a level two or level three cache, and so the data source of the prefetched cache line may be dependent on this.

In examples, the latency determination circuitry is configured to predict the total latency based on determining, for a given data source, an average total latency of other memory load requests that target data in the given data source, the average total latency being indicative of an average amount of time between when the other memory load requests start executing and when the other memory load requests complete. Hence, the total latency of other memory load requests (which have not been prefetched) can be measured and used to predict the total latency of a memory load request which has been prefetched and for which measurement of the total latency may not be possible.

In some examples, the latency determination circuitry is configured to predict the total latency based on the average total latency associated with a given data source that corresponds to the data source of the prefetched cache line. The present inventor has identified that the total latency associated with accessing data in a given data source can be a reliable indicator of the total latency that would have been experienced by a memory load request had the memory load request not been prefetched from that data source. Thus, by determining average total latency of other memory load requests that target data in a given data source, this information can be used to predict the total latency of the memory load request that has been prefetched.

In examples, for non-prefetched cache lines, the total latency can be directly measured (because the cache line has not been prefetched). Thus, an average total latency per data source can be determined, to increase the accuracy of the prediction of the total latency.

In some examples, the other memory load requests correspond to one or more of: a level two cache hit; a level three cache hit; and a level three cache miss. Thus, average total latencies associated with cache hits and misses from different data sources may be determined and used to inform the prediction of the total latency for the memory load request.

In some examples, the latency determination circuitry is configured to determine the predicted exposed latency based on subtracting the hidden latency from the total latency. In this way, the predicted exposed latency can be determined based on measurable quantities without affecting the behavior of the latency of the memory load itself. It will be appreciated that the predicted exposed latency may be zero if the hidden latency is greater than the total latency.

In some examples, the cache that the data stored at the address in memory targeted by the memory load request has been prefetched into is a lowest-level cache. For example, a fastest cache in a multi-level cache hierarchy. In some implementations, the lowest-level cache (i.e. the fastest cache) may be referred to as a level zero cache or first-level cache (L1 cache).

In some examples, the prefetch control circuitry is configured to control issuing of prefetch requests targeting the address targeted by the memory load request based on the predicted exposed latency. Thus, the predicted exposed latency can be used to inform subsequent prefetching. In this way, the likelihood that a memory load will be prefetched unnecessarily is reduced, thereby reducing the likelihood that memory bandwidth is used for unnecessary prefetching. Further, by using a predicted exposed latency as discussed herein, the latency of a prefetched memory load can be determined without affecting the latency actually experienced by the memory load, thus avoiding the cyclical pattern of behaviour discussed herein that results in increased memory bandwidth and processing resource usage.

In some examples, the prefetch control circuitry is configured to determine whether to issue or suppress issuing a prefetch request targeting the address in memory targeted by the memory load request based on determining whether the predicted exposed latency satisfies a condition. Hence, prefetching can be efficiently controlled based on the predicted exposed latency.

In some examples, the prefetch control circuitry is configured to issue a prefetch request targeting the address in memory targeted by the memory load request based on determining that the predicted exposed latency satisfies a condition. In some examples, the prefetch control circuitry is configured to suppress issuing of a prefetch request targeting the address in memory targeted by the memory load request based on determining that the predicted exposed latency does not satisfy a condition. Hence, prefetching can be controlled based on the predicted exposed latency. In this way, the likelihood that a memory load will be prefetched unnecessarily is reduced, thereby reducing the likelihood that memory bandwidth is used for unnecessary prefetching.

In some examples, the condition comprises one or more of: a predetermined predicted exposed latency threshold, and a ranking condition associated with a ranking of a plurality of predicted exposed latencies. For example, when the predetermined predicted exposed latency threshold or ranking condition is satisfied, a prefetch request may be issued. It will be appreciated that the condition may be defined in a number of ways depending on implementation, and in some examples may be defined in a different manner, for example where the condition is satisfied when the predicted exposed latency is not less than a minimum predetermined threshold.

Specific examples will now be described with reference to the drawings.

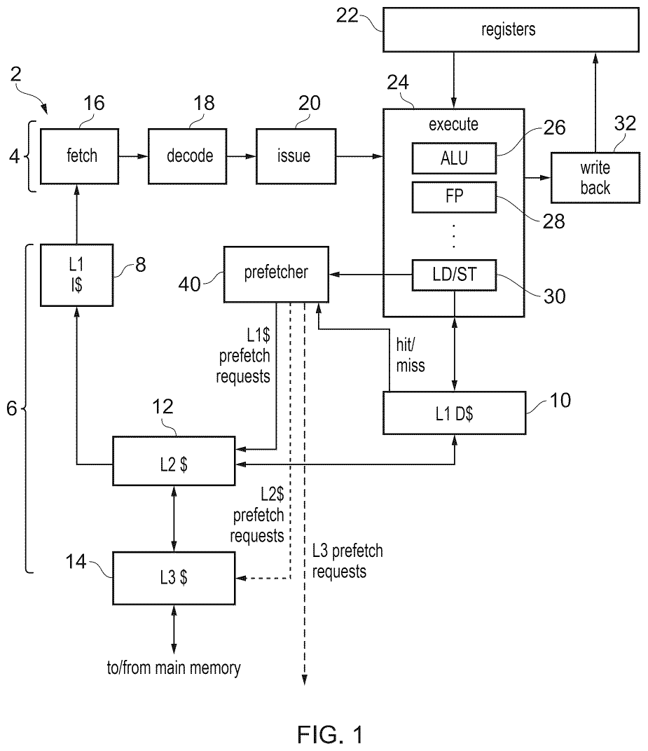

FIG. 1 illustrates an example of a data processing apparatus 2. The apparatus 2 has a processing pipeline 4 for processing program instructions fetched from a memory system 6. The memory system 6 in this example includes a level 1 instruction cache 8, a level 1 data cache 10, a level 2 cache 12 shared between instructions and data, a level 3 cache 14, and main memory which is not illustrated in FIG. 1 but may be accessed in response to requests issued by the processing pipeline 4. It will be appreciated that other examples could have a different arrangement of caches with different numbers of cache levels or with a different hierarchy regarding instruction caching and data caching (e.g. different numbers of levels of cache could be provided for the instruction caches compared to data caches).

The processing pipeline 4 includes a fetch stage 16 for fetching program instructions from the instruction cache 8 or other parts of the memory system 6. The fetched instructions are decoded by a decode stage 18 to identify the types of instructions represented and generate control signals for controlling downstream stages of the pipeline 4 to process the instructions according to the identified instruction types. The decode stage passes the decoded instructions to an issue stage 20 which checks whether any operands required for the instructions are available in registers 22 and issues an instruction for execution when its operands are available (or when it is detected that the operands will be available by the time they reach the execute stage 24). The execute stage 24 includes a number of functional units 26, 28, 30 for performing the processing operations associated with respective types of instructions. For example, in FIG. 1 the execute stage 24 is shown as including an arithmetic/logic unit (ALU) 26 for performing arithmetic operations such as add or multiply and logical operations such as AND, OR, NOT, etc. Also the execute unit includes a floating point unit 28 for performing operations involving operands or results represented as a floating-point number. Also the functional units include a load/store unit 30 for executing load instructions to load data from the memory system 6 to the registers 22 or store instructions to store data from the registers 22 to the memory system 6. Load requests issued by the load/store unit 30 in response to executed load instructions may be referred to as demand load requests or memory load requests. Store requests issued by the load/store unit 30 in response to executed store instructions may be referred to as demand store requests. It will be appreciated that the functional units shown in FIG. 1 are just one example, and other examples could have additional types of functional units, or could have multiple functional units of the same type, or may not include all of the types shown in FIG. 1 (e.g. some processors may not have support for floating-point processing). The results of the executed instructions are written back to the registers 22 by a write back stage 32 of the processing pipeline 4.

It will be appreciated that the pipeline architecture shown in FIG. 1 is just one example and other examples could have additional pipeline stages or a different arrangement of pipeline stages. For example, in an out-of-order processor a register rename stage may be provided for mapping architectural registers specified by program instructions to physical registers identifying the registers 22 provided in hardware. Also, it will be appreciated that FIG. 1 does not show all of the components of the data processing apparatus and that other components could also be provided. For example, a branch predictor may be provided to predict outcomes of branch instructions so that the fetch stage 16 can fetch subsequent instructions beyond the branch earlier than if waiting for the actual branch outcome. Also a memory management unit could be provided for controlling address translation between virtual addresses specified by the program instructions and physical addresses used by the memory system.

As shown in FIG. 1, the data processing apparatus 2 has a prefetcher 40 (also known as prefetcher circuitry 40) for analyzing patterns of demand target addresses specified by demand memory access requests issued by the load/store unit 30, and detecting address access patterns which can subsequently be used to predict addresses of future memory accesses. For example, the address access patterns may involve stride sequences of addresses where there are a number of addresses separated at regular intervals of a constant stride value. It is also possible to detect other kinds of address access patterns (e.g. a pattern where subsequent accesses target addresses at certain offsets from a start address). The prefetcher 40 maintains prefetch state information representing the observed address access patterns, and uses the prefetch state information to generate prefetch requests which are issued to the memory system 6 to request that data is brought into a given level of cache. For example, when a trigger event for a given access pattern is detected (e.g. the trigger event could be program flow reaching a certain program counter address, or a load access to a particular trigger address being detected), the prefetcher 40 may begin issuing prefetch requests for addresses determined according to that pattern. The prefetch requests are not directly triggered by a particular instruction executed by the pipeline 4, but are issued speculatively with the aim of ensuring that when a subsequent load/store instruction reaches the execute stage 24, the data it requires may already be present within one of the caches, to speed up the processing of that load/store instruction and therefore reduce the likelihood that the pipeline has to be stalled.

The prefetcher 40 may be able to perform prefetching into a single cache or into multiple caches. For example, FIG. 1 shows an example of the prefetcher 40 issuing level 1 cache prefetch requests which are sent to the level 2 cache 12 or downstream memory and request that data from prefetch target addresses is brought into the level 1 data cache 10. Also the prefetcher 40 in this example could also issue level 2 prefetch requests to the level 3 cache 14 or main memory requesting that data from prefetch target addresses is loaded into the level 2 cache 14, and/or level 3 prefetch requests to the main memory requesting that data from prefetch target addresses is loaded into the level 3 cache 14. The level 2 or level 3 prefetch requests may look a longer distance into the future than the level 1 prefetch requests to account for the greater latency expected in obtaining data from main memory into the level 2 or 3 cache 12, 14 compared to obtaining data from a level 2 cache into the level 1 cache 10. In systems using prefetching into multiple levels of cache, prefetches at level 2 or 3 can increase the likelihood that data requested by a level 1 prefetch request or demand access request is already in the level 2 or 3 cache. However, it will be appreciated that the particular caches loaded based on the prefetch requests may vary depending on the particular circuit implementation.

As shown in FIG. 1, as well as the demand target addresses issued by the load/store unit 30, the training of the prefetcher 40 may also be based on an indication of whether the corresponding demand memory access requests hit or miss in the level 1 data cache 10. The hits/miss indication can be used for filtering the demand target addresses from training. This recognises that it is not useful to expend prefetch resource on addresses for which the demand target addresses would anyway hit in the cache. Performance improvement can be greater in focusing prefetcher training on those addresses which, in the absence of prefetching, would have encountered cache misses for the demand access requests, and thus may be more likely to cause a pipeline stall.

While FIG. 1 shows a single instance of a prefetcher 40, it will be appreciated that some implementations may comprise more than one prefetcher, e.g. prefetchers trained to detect different kinds of memory access patterns and/or prefetchers trained on memory access requests processed by different levels of caches. It will be further appreciated that some implementations may comprise a hierarchy of multiple prefetchers, where the input of a prefetcher lower in the hierarchy is the output or prediction of a prefetcher higher in the hierarchy. It will further be appreciated that the prefetcher 40 may implement various prefetching techniques, including stride prefetching, best-offset prefetching, or indirect prefetching, and the prefetching technique is not particularly limited in this respect.

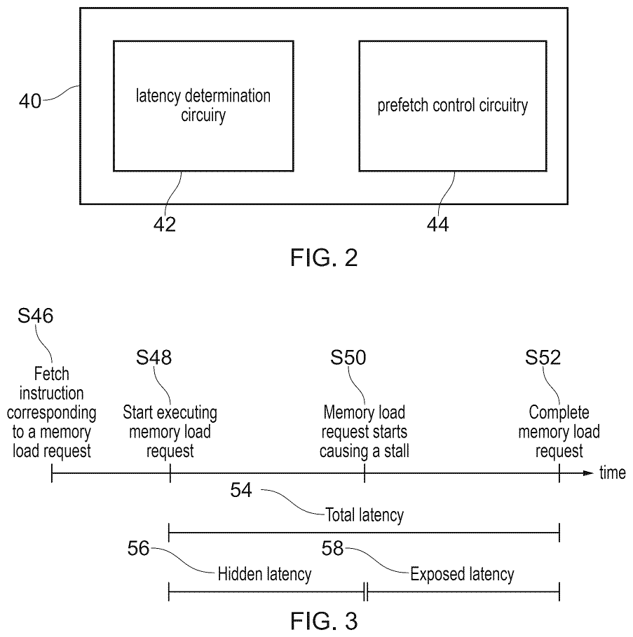

FIG. 2 illustrates an example of prefetcher circuitry 40, for example prefetcher 40 of FIG. 1, according to the present technique. Prefetcher circuitry 40 includes latency determination circuitry 42 and prefetch control circuitry 44. However, it will be appreciated that the latency determination circuitry may be provided separate from the prefetcher 40 in some implementations.

Latency determination circuitry 42 determines a predicted exposed latency associated with a memory load request targeting an address in memory, the predicted exposed latency corresponding to a stall that would be caused by waiting for the memory load request to complete had the data stored at the address in memory targeted by the memory load request not been prefetched into a cache. Prefetch control circuitry 44 controls issuing of prefetch requests to prefetch data from a memory system based on the predicted exposed latency, such as prefetch requests targeting the address targeted by the memory load request. For example, prefetch control circuitry 44 may determine whether to issue or suppress issuing a prefetch request targeting the address in memory targeted by the memory load request based on determining whether the predicted exposed latency satisfies a condition (such as a predetermined predicted exposed latency threshold, or a ranking condition associated with a ranking of a plurality of predicted exposed latencies). Prefetch control circuitry 44 may then issue or suppress issuing (i.e. not issue) a prefetch request based on whether the predicted exposed latency satisfies the condition.

Exposed latency, hidden latency, and total latency will now be described further with reference to FIGS. 3, 4, and 5.

FIG. 3 shows example steps of a processing pipeline and their relative timing for a memory load request that has not been prefetched and that causes a stall to the processing pipeline, and the relationship between total latency, hidden latency and exposed latency. FIG. 3 thus illustrates an example where all of the total latency, hidden latency, and exposed latency can be directly measured.

The processing pipeline starts with the fetching of an instruction corresponding to a memory load request at S46. As described in relation to FIG. 1, a load instruction may cause a memory load request (i.e. demand load request) to be issued. At S48, the memory load request starts executing. It will be appreciated that in some examples S48, i.e. when the memory load request starts executing, may correspond to when the instruction corresponding to the memory load request starts executing. The difference in time (i.e. time period) between when the memory load request starts executing at S48 to when the memory load request completes at S52 is defined as the total latency 54 (i.e. an actual total latency). It will be appreciated that memory request completion refers to when accessing of the data in the memory system is complete (i.e. that the data has been retrieved from the memory system).

As shown in FIG. 3, the memory load request starts causing a stall at S50 at a point in time before the memory load request completes at S52. The difference in time between when the memory load request starts executing at S48 and when the memory load request starts causing a stall at S50 is defined as the hidden latency 56 (i.e. an actual hidden latency). In an out-of-order processing implementation, it will be appreciated that during this time other instructions may be performed in parallel, for example, and so the latency is ‘hidden’ by the execution of these other instructions, in the sense that the memory load request is not itself responsible for a delay or stall experienced by the processing pipeline. However, once the memory load request starts causing a stall at S50, the latency is no longer hidden and instead is exposed, in the sense that the stall is caused by waiting for the memory load request itself to complete (other instructions having already completed). It will be appreciated that in in-order processing implementations hidden latency may still be present.

Thus, the time period between the point when the memory load request starts causing a stall at S50 and when the memory load request completes is defined as the exposed latency 58 (i.e. an actual exposed latency). As discussed herein, the point when the memory load request starts causing a stall at S50 may correspond to when the memory load request is at a head of a load queue, re-order buffer, or in-order pipeline, for example. However, it will be appreciated that in some cases a stall may not be caused by a memory load request just because it is at the head of a load queue or re-order buffer because there might be other instructions that can still be executed.

As shown in FIG. 3, the total latency 54 comprises the hidden latency 56 and the exposed latency 58, and the total latency 54 is calculated by addition of the hidden latency 56 and the exposed latency 58. In other words, the actual total latency =actual hidden latency +actual exposed latency.

It will be appreciated that FIG. 3 shows only one example, and in some cases the memory load request may complete before a point when the memory load request would start causing a stall, i.e. S52 may occur earlier in time than S50. In this example, the exposed latency would be zero, and the total latency 54 would be equal to the hidden latency 56. Such an example may occur for a low total latency memory load request, for example.

It is assumed that out-of-order processing is being performed in the examples of FIGS. 3, 4, and 5, where a processor may start executing an instruction before a previous instruction completes. Indeed, in some examples, an out-of-order processing element is provided to perform out-of-order execution of instructions. However, it will be appreciated that the present technique may also apply to in-order processing.

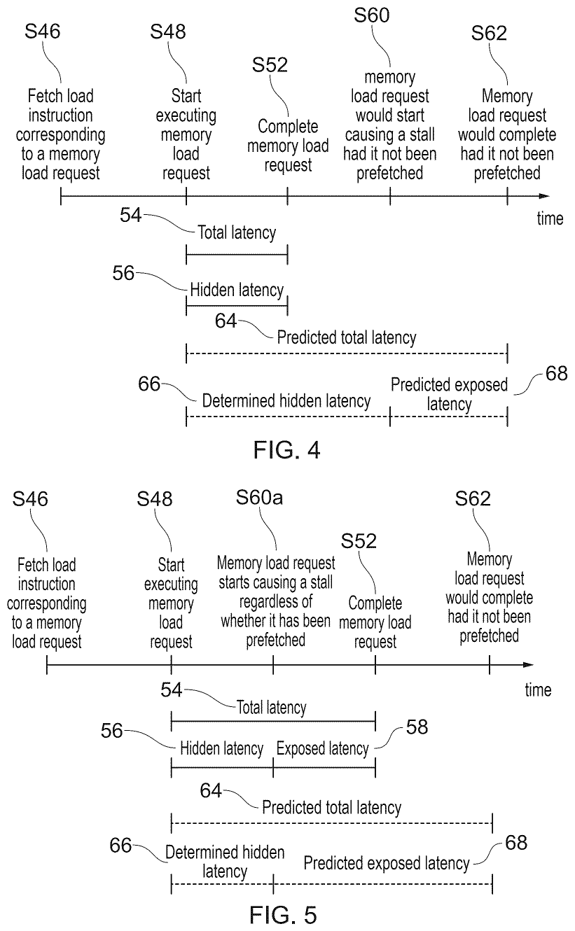

Example latency behavior for a prefetched memory load request will now be discussed with reference to FIGS. 4 and 5. FIGS. 4 and 5 show example steps of a processing pipeline and their relative timing for a memory load request that has been prefetched.

As discussed herein, prefetching may cause the exposed latency (and thus total latency) associated with a memory load request to reduce. This is illustrated in FIG. 4. In particular, because the memory load request has been prefetched, the memory load request completes at S52 before a point, S60, when the memory load request would start causing a stall had it not been prefetched (i.e. in contrast to FIG. 3). In this example, the exposed latency 58 for the prefetched memory load request of FIG. 4 is zero (i.e. the actual exposed latency). While the hidden latency 56 is measured between the point when the memory load request starts executing at S48 and when the memory load request would start causing a stall had it not been prefetched at S60, in this example the memory load request completes at S52 before S60. Thus, the hidden latency 56 is equal to the total latency 54 (because the hidden latency 56 can at most be equal to the total latency).

FIG. 4 therefore illustrates what ideal behavior for a prefetched memory load request would look like, in that the actual exposed latency is zero. It will be appreciated that in some cases the actual exposed latency may be greater than zero even for memory load requests that have been prefetched (this is discussed further below with reference to FIG. 5).

As discussed herein, if prefetching were to be controlled based on measuring the actual total latency (or the actual exposed latency) of the prefetched memory load request, the cyclical pattern of behavior discussed herein would be experienced because by prefetching the memory load request, the actual exposed latency is reduced. However, once prefetching for that memory load request is stopped because the actual total latency or actual exposed latency is no longer considered critical (i.e. below a predetermined threshold), the actual exposed latency will increase again (and so will the actual total latency), resulting in the memory load request being considered critical again and thus requiring prefetching.

FIG. 4 also illustrates how, by using a predicted total latency 64, determined hidden latency 66, and predicted exposed latency 68 according to the present techniques, the cyclical pattern of behavior discussed herein can be avoided. Indeed, by using a predicted exposed latency to determine whether to prefetch as discussed herein, the latency of a prefetched memory load can be determined without affecting the exposed latency actually experienced by the memory load, thereby avoiding the cyclical pattern of behaviour discussed herein that results in increased memory bandwidth and processing resource usage.

The predicted total latency 64 corresponds to a time difference between when the memory load request starts executing at S48 (or the load instruction starts executing), and when the memory load request would have completed had it not been prefetched at S62. As discussed herein and further below, the predicted total latency 64 may be predicted based on a data source of the prefetched cache line containing the data stored at the address in memory targeted by the memory load request (i.e. a data source where the data was prefetched from). Thus, for the prefetched memory load request, a data source for where the data targeted by the memory load request was prefetched from can be determined. Average total latencies for other memory requests targeting data in data sources may be determined and tracked over time and the predicted total latency 64 may be predicted based on the average total latency associated with a data source that corresponds to the data source of the prefetched cache line that contains the data stored at the address targeted by the memory load request.

The determined hidden latency 66 corresponds to a time difference between when the memory load request starts executing at S48 and when the memory load request would start causing a stall had the memory load request not been prefetched (S60). S60 may be determined in a similar way to S50 of FIG. 3, and thus may correspond to a point in time when the memory load request reaches the head of a load queue, re-order buffer, or in-order processing pipeline. Thus, the determined hidden latency 66 can be measured based on timestamps corresponding to when the memory load request starts executing (S48) and when the memory load request reaches a point in the processing pipeline where if it hadn't been prefetched it would cause a stall (such as the head of a load queue, re-order buffer, in-order pipeline, etc.) (S60).

The predicted exposed latency 68 corresponds to a time difference between when the memory load request would start causing a stall had it not been prefetched (S60) and when the memory load request would have completed had it not been prefetched (S62).

The predicted exposed latency 68 cannot be directly measured because the memory load request was actually prefetched. However, the predicted exposed latency 68 can be predicted based on determining the predicted total latency 64 and the determined hidden latency 66. In particular, by subtracting the determined hidden latency 66 from the predicted total latency 64 the predicted exposed latency 68 can be determined.

As mentioned above, prefetching may not completely remove an actual exposed latency. This is illustrated by FIG. 5, which shows the same example as FIG. 4 except that S60 is replaced with S60a, which is a point at which the memory load starts causing a stall regardless of whether it has been prefetched (i.e. the stall occurs at this point whether or not the memory load request has been prefetched, and thus may in some examples correspond to an inherent exposed latency present even when prefetching).

In this example, the exposed latency 58 (i.e. actual exposed latency) is measured between when the memory load request starts causing a stall (S60a) and when the memory load request completes at S52, and the predicted exposed latency 68 is measured between S60a (i.e. the point that a stall would be caused had it not been prefetched, which is also the point where the stall occurs even with prefetching) and when the memory load request would complete had it not been prefetched at S62. Thus, it will be appreciated that the actual exposed latency 58 and the predicted exposed latency 68 can in some examples overlap, in that the predicted exposed latency 68 may include an inherent exposed latency that is incurred even in the case of prefetching. In this example, because the memory load request starts causing a stall at the same point regardless of whether it has been prefetched (i.e. S60a), the actual hidden latency 56 and the determined hidden latency 66 are measured between the same points (i.e. between S48 and S60a).

Thus, even in a case where a memory load request is prefetched and exposed latency remains, the predicted exposed latency can be determined and used to control the issuing of prefetch requests.

It will be appreciated that FIGS. 4 and 5 illustrate example scenarios and that other scenarios are possible. For example, it will be appreciated that a stall duration and position may vary in other example scenarios.

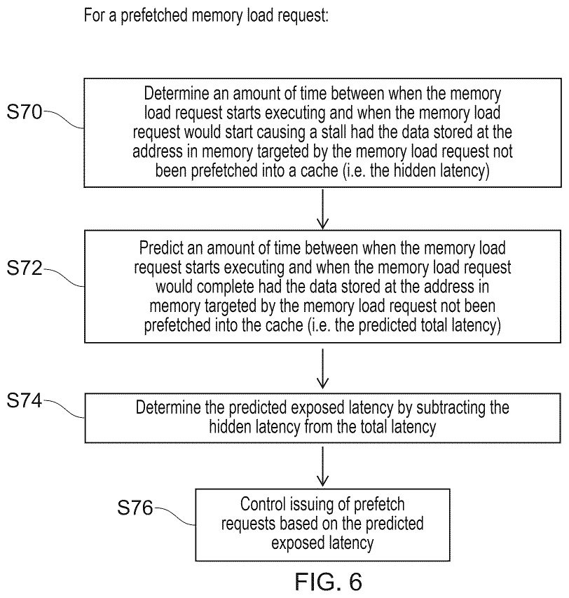

Example steps for determining the predicted exposed latency and controlling issuing of prefetch requests will now be described with reference to FIG. 6. FIG. 6 applies to a prefetched memory load request, i.e. a memory load request that targets an address in memory having data prefetched into a cache. The cache may be the lowest level cache (i.e. the fastest) in a multi-level cache hierarchy, for example, but may also be a cache at a different level in the multi-level cache hierarchy.

At S70, an amount of time between when the memory load request starts executing and when the memory load request would start causing a stall had the data stored at the address in memory targeted by the memory load request not been prefetched into a cache (i.e. the hidden latency) is determined. As discussed herein, this may comprise determining a difference between a point in time when the memory load request starts executing and a point in time when the memory load request reaches a point where, had the memory load request not been prefetched, the memory load request could cause a stall. For example, this point may be when the memory load request reaches the head of a load queue, the head of a re-order buffer, or in an in-order pipeline etc.

At S72, an amount of time between when the memory load request starts executing and when the memory load request would complete had the data stored at the address in memory targeted by the memory load request not been prefetched into the cache (i.e. the predicted total latency) is predicted. As discussed in further detail below, this may be based on a data source of a prefetched cache line containing the data stored at the address targeted by the memory load request. In some examples, an average total latency of the M most recent memory accesses targeting data in a plurality of different data sources is tracked, thereby accounting for changes in latency throughout a software program.

At S74, the predicted exposed latency is determined by subtracting the hidden latency from the total latency. With reference to FIG. 6, S74 comprises determining the predicted exposed latency 68 by subtracting the determined hidden latency 66 from the predicted total latency 64.

At S76, issuing of prefetch requests based on the predicted exposed latency is controlled. As discussed herein, this may be based on whether the predicted exposed latency satisfies a condition. In examples, the condition may be indicative of load criticality (i.e. whether the load will cause a processing stall).

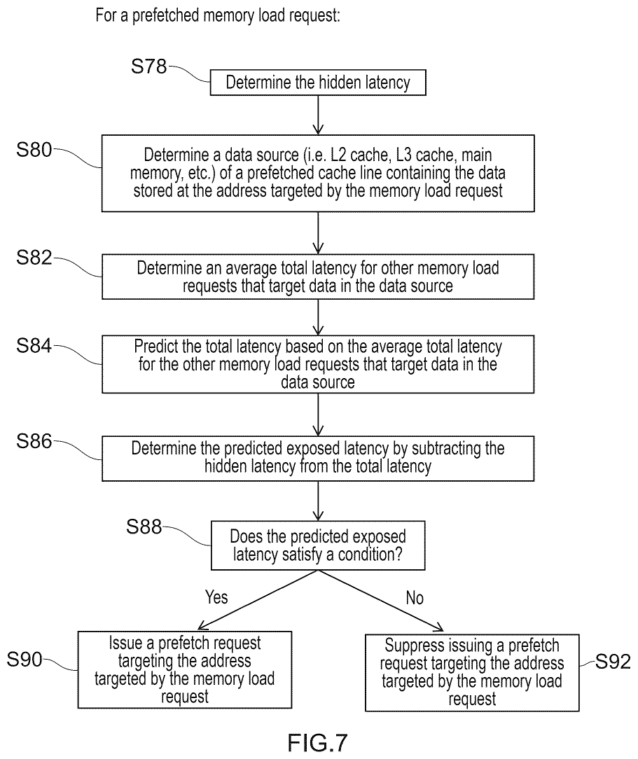

FIG. 7 shows a similar process to FIG. 6. The determination of the hidden latency at S78 of FIG. 7 corresponds to S70 of FIG. 6, and so discussion of this step is not repeated here.

At S80, a data source (i.e. L2 cache, L3 cache, main memory, etc.) of a prefetched cache line containing the data stored at the address targeted by the memory load request is determined (i.e. because the data/cache line containing the data has been prefetched, the data source of where the data/cache line containing the data can be determined). In examples, the data source of prefetched cache lines is tracked and thus may be used to inform the determination of where the cache line was prefetched from.

At S82 an average total latency for other memory load requests that target data in the data source (i.e. the data source of S80) is determined. For example, if the data source determined at S80 is the L2 cache, i.e. because a cache line in a L1 cache that contains the data that is stored at the address targeted by the memory load request was prefetched from the L2 cache, an average total latency for other memory load requests that target data in the L2 cache is determined. As mentioned, the present inventor has identified that the data source can be used as a reliable indicator for the total latency and so by looking at average total latencies of other memory requests that target the same data source that the data in the cache was prefetched from, the other memory requests can be used as a reliable indicator/proxy for the total latency of the memory load request. In some examples, an average total latency of the M most recent memory accesses is tracked, thereby accounting for changes in latency throughout a software program.

At S84, the total latency (of the memory load request had it not been prefetched) is predicted based on the average total latency for the other memory load requests that target data in the data source. In some examples, the total latency may be predicted as the average total latency for the other memory load requests. As discussed, total latencies for each of a number of recent memory accesses that target data in each of a number of data sources may be determined. The total latencies for the number of recent memory accesses that target a given data source may be averaged, to determine an average total latency for a memory request that targets data in a given data source. The average may be determined by summing the total latencies of memory load requests that target a given data source and dividing the summed total latencies by the number of memory load requests that target the given data source. For example, the total latency of each of M recent memory load requests that target data in the L2 cache may be determined and averaged to provide an average total latency for a memory load request that targets data in the L2 cache. This may be determined for one or more of the L2 cache, L3, the system level cache, and main memory. Following this example, when data targeted by the memory load request is prefetched from the L2 cache, the total latency can be predicted by using the average total latency of other memory requests that target data in the L2 cache.

At S86, the predicted exposed latency is determined by subtracting the hidden latency from S78 from the total latency predicted at S84.

At S88, it is determined whether the predicted exposed latency satisfies a condition. In examples, the condition may be a predetermined predicted exposed latency threshold or a ranking condition. For example, the predicted exposed latencies associated with a plurality of memory load requests may be determined and a top slice of the N greatest predicted exposed latencies may be considered to satisfy the condition, where N is a predetermined number.

If it is determined at S88 that the condition is satisfied, at S90 a prefetch request targeting the address targeted by the memory load request is issued. Hence, a prefetch is generated for the memory load request because it has been determined that the condition is satisfied (i.e. that the load is critical for example).

If it is determined at S88 that the condition is not satisfied, at S92 a prefetch request targeting the address targeted by the memory load request is suppressed from being issued. In examples, this may correspond to not issuing a prefetch request. Hence, a prefetch request for the memory load request is not issued (or generated) because the condition is not satisfied (i.e. the load is not considered critical).

In this way, the issuing of prefetch requests can be controlled based on the predicted exposed latency of a memory load request.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

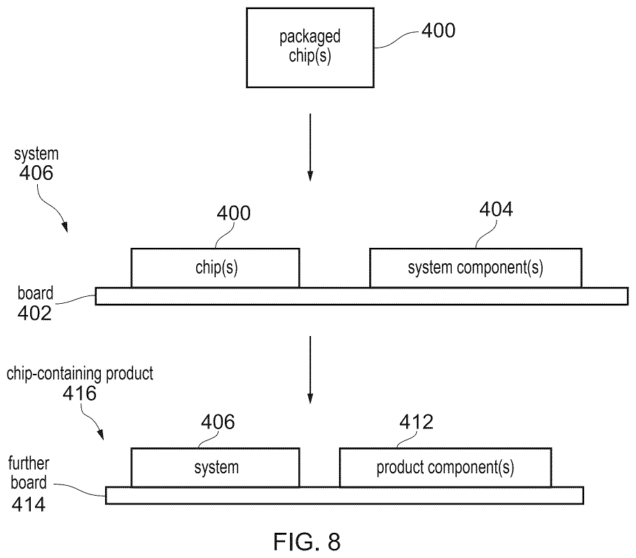

As shown in FIG. 8, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
Clause 1. An apparatus comprising:
   latency determination circuitry configured to determine a predicted exposed latency associated with a memory load request targeting an address in memory, the predicted exposed latency corresponding to a stall that would be caused by waiting for the memory load request to complete had the data stored at the address in memory targeted by the memory load request not been prefetched into a cache; and
   prefetch control circuitry configured to control issuing of prefetch requests to prefetch data from a memory system based on the predicted exposed latency.
Clause 2. The apparatus of clause 1, in which the latency determination circuity is configured to determine the predicted exposed latency that would be caused had the data stored at the address in memory targeted by the memory load request had not been prefetched into the cache even when the data stored at the address in memory targeted by the memory load request has actually been prefetched into the cache.
Clause 3. The apparatus of any preceding clause, in which the latency determination circuitry is configured to determine the predicted exposed latency based on determining a hidden latency, the hidden latency corresponding to an amount of time between when the memory load request starts executing and when the memory load request would start causing the stall had the data stored at the address in memory targeted by the memory load request not been prefetched into the cache.
Clause 4. The apparatus of any preceding clause, in which the latency determination circuitry is configured to determine the predicted exposed latency based on predicting a total latency, the total latency being indicative of an amount of time between when the memory load request starts executing and when the memory load request would complete had the data stored at the address in memory targeted by the memory load request not been prefetched into the cache.
Clause 5. The apparatus of clause 4, in which the latency determination circuitry is configured to predict the total latency based on determining a data source of a prefetched cache line containing the data stored at the address in memory targeted by the memory load request.
Clause 6. The apparatus of clause 4 or 5, in which the latency determination circuitry is configured to predict the total latency based on determining, for a given data source, an average total latency of other memory load requests that target data in the given data source, the average total latency being indicative of an average amount of time between when the other memory load requests start executing and when the other memory load requests complete.
Clause 7. The apparatus of clause 6, in which the latency determination circuitry is configured to predict the total latency based on the average total latency associated with a given data source that corresponds to the data source of the prefetched cache line.
Clause 8. The apparatus of clauses 6 or 7, in which the other memory load requests correspond to one or more of: a level two cache hit; a level three cache hit; and a level three cache miss.
Clause 9. The apparatus of any of clauses 5 to 8, in which the data source is one of: a level two cache, a level three cache, and main memory.
Clause 10. The apparatus of any of clauses 3 to 9, in which the latency determination circuitry is configured to determine the predicted exposed latency based on subtracting the hidden latency from the total latency.
Clause 11. The apparatus of any preceding clause, in which the cache that the data stored at the address in memory targeted by the memory load request has been prefetched into is a lowest-level cache.
Clause 12. The apparatus of any preceding clause, in which the prefetch control circuitry is configured to control issuing of prefetch requests targeting the address targeted by the memory load request based on the predicted exposed latency.
Clause 13. The apparatus of any preceding clause, in which the prefetch control circuitry is configured to determine whether to issue or suppress issuing a prefetch request to prefetch data from the memory system based on determining whether the predicted exposed latency satisfies a condition.
Clause 14. The apparatus of any preceding clause, in which the prefetch control circuitry is configured to issue a prefetch request targeting the address in memory targeted by the memory load request based on determining that the predicted exposed latency satisfies a condition.
Clause 15. The apparatus of any preceding clause, in which the prefetch control circuitry is configured to suppress issuing of a prefetch request targeting the address in memory targeted by the memory load request based on determining that the predicted exposed latency does not satisfy a condition.
Clause 16. The apparatus of any of clauses 13 to 15, in which the condition comprises one or more of: a predetermined predicted exposed latency threshold, and a ranking condition associated with a ranking of a plurality of predicted exposed latencies.
Clause 17. A system comprising:
   the apparatus of any preceding clause, implemented in at least one packaged chip;
   at least one system component; and
   a board,
      wherein the at least one packaged chip and the at least one system component are assembled on the board.
Clause 18. A chip-containing product comprising the system of clause 17, wherein the system is assembled on a further board with at least one other product component.
Clause 19. A non-transitory computer-readable medium storing computer-readable code for fabrication of the apparatus of any of clauses 1 to 16.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
latency determination circuitry configured to determine a predicted exposed latency associated with a memory load request targeting an address in memory, the predicted exposed latency corresponding to a stall that would be caused by waiting for the memory load request to complete had the data stored at the address in memory targeted by the memory load request not been prefetched into a cache; and
prefetch control circuitry configured to control issuing of prefetch requests to prefetch data from a memory system based on the predicted exposed latency.

2. The apparatus of claim 1, in which the latency determination circuity is configured to determine the predicted exposed latency that would be caused had the data stored at the address in memory targeted by the memory load request had not been prefetched into the cache even when the data stored at the address in memory targeted by the memory load request has actually been prefetched into the cache.

3. The apparatus of claim 1, in which the latency determination circuitry is configured to determine the predicted exposed latency based on determining a hidden latency, the hidden latency corresponding to an amount of time between when the memory load request starts executing and when the memory load request would start causing the stall had the data stored at the address in memory targeted by the memory load request not been prefetched into the cache.

4. The apparatus of claim 1, in which the latency determination circuitry is configured to determine the predicted exposed latency based on predicting a total latency, the total latency being indicative of an amount of time between when the memory load request starts executing and when the memory load request would complete had the data stored at the address in memory targeted by the memory load request not been prefetched into the cache.

5. The apparatus of claim 4, in which the latency determination circuitry is configured to predict the total latency based on determining a data source of a prefetched cache line containing the data stored at the address in memory targeted by the memory load request.

6. The apparatus of claim 5, in which the latency determination circuitry is configured to predict the total latency based on determining, for a given data source, an average total latency of other memory load requests that target data in the given data source, the average total latency being indicative of an average amount of time between when the other memory load requests start executing and when the other memory load requests complete.

7. The apparatus of claim 6, in which the latency determination circuitry is configured to predict the total latency based on the average total latency associated with a given data source that corresponds to the data source of the prefetched cache line.

8. The apparatus of claim 7, in which the other memory load requests correspond to one or more of: a level two cache hit; a level three cache hit; and a level three cache miss.

9. The apparatus of claim 8, in which the data source is one of: a level two cache, a level three cache, and main memory.

10. The apparatus of claim 9, in which the latency determination circuitry is configured to determine the predicted exposed latency based on subtracting the hidden latency from the total latency.

11. The apparatus of claim 1, in which the cache that the data stored at the address in memory targeted by the memory load request has been prefetched into is a lowest-level cache.

12. The apparatus of claim 1, in which the prefetch control circuitry is configured to control issuing of prefetch requests targeting the address targeted by the memory load request based on the predicted exposed latency.

13. The apparatus of claim 1, in which the prefetch control circuitry is configured to determine whether to issue or suppress issuing a prefetch request to prefetch data from the memory system based on determining whether the predicted exposed latency satisfies a condition.

14. The apparatus of claim 1, in which the prefetch control circuitry is configured to issue a prefetch request targeting the address in memory targeted by the memory load request based on determining that the predicted exposed latency satisfies a condition.

15. The apparatus of claim 1, in which the prefetch control circuitry is configured to suppress issuing of a prefetch request targeting the address in memory targeted by the memory load request based on determining that the predicted exposed latency does not satisfy a condition.

16. The apparatus of claim 15, in which the condition comprises one or more of: a predetermined predicted exposed latency threshold, and a ranking condition associated with a ranking of a plurality of predicted exposed latencies.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of the apparatus of claim 1.
